(19) United States
(12) Patent Application Publication
(10) Pub. No.: US 2010/0295397 A1
(43) Pub. Date: Nov. 25, 2010

(54) Electromechanical Machine

(76) Inventors: William F. Dowis, ROCKWALL, TX (US); Mark A. Marsing, San Clemente, CA (US)

Correspondence Address: Mark A. Marsing, 146 Avenida Presidio, San Clemente, CA, 92672, US

(21) Appl. No.: 12/784,321

(22) Filed: May 20, 2010

Related U.S. Application Data
(60) Provisional application No. 61/179,979, filed on May 20, 2009.

(51) Int. Cl. H02K 19/00; H02K 5/173; H01R 39/12

(52) U.S. Cl. 310/90; 310/179; 310/219

(57) ABSTRACT

An electromechanical machine capable of functioning as an electric motor or generator/alternator with a wound rotor fitted between wound coaxial stator elements that engage magnetically both the inner and outer circumference of the rotor. The rotor is excited via conduction thru the ball bearings via a commutation device that provides for simultaneous excitation of the stator elements and the rotor.

### CROSS-REFERENCE TO RELATED APPLICATIONS

This application claims the benefit of provisional patent application number 61/179,979 filed May 20, 2009 by the present inventors.

### FEDERALLY SPONSORED RESEARCH OR DEVELOPMENT

Not applicable

### SEQUENCE LISTING OR PROGRAM

Not applicable

### BACKGROUND OF THE INVENTION

Currently available electromechanical machines (motors and generators) either convert electrical power to linear or rotational force or convert these forces to electrical power when driven by an external source. These machines utilize wound coils that are arranged so as to develop magnetic flux that is predominantly axial to a shaft that delivers rotational power or receives input torque. These devices develope all or the majority of the magnetic flux tangentially or at a 90° vector relevant to the ark, radius or circumference of rotation.

The currently available motor/generator technologies impose severe limitations on the implementer of the device. All but ironless/coreless machines are severely limited by hysteresis and eddy current losses. Ironless/coreless motors, however, are severely limited by the constraints imposed by permanent magnets. Any device that incorporates the permanent magnet is by design limited to performance (maximum torque) predicated on the characteristics of the permanent magnet.

Induction machines are burdened by significant heating and efficiency losses by virtue of the steel (laminations) applied as the medium for all induced magnetic flux. This variety of motor is also hindered by its inherent rotor construction that by necessity is small in diameter and inefficient as a flux transfer medium (necessity of design).

Brushless devices are in essence alternating current machines that incorporate an integral electronic package or commutation system. This variety of machine is severely limited by the constants imposed by the permanent magnet and the aforementioned effects of steel laminations. The need for an electronic commutation system imposes significant cost factors.

Our invention utilizes electromagnets in the stator and rotor and is devoid of any performance inhibitors related to iron and/or permanent magnets. The permanent magnet variant described herein is devoid of the limitations of motors not establishing magnetic flux on the arc/radius/diameter of rotation.

Existing direct current motors and generators are beset by limited service endurance resulting from reliance on mechanical commutators (brushes). Alternating current or AC motors are of the single phase or three-phase classification are predominantly of design classification termed the induction variety. An extension of the permanent magnet alternating current motors has emerged; this variety of motor is known as the brushless DC or electronically commutated AC motor. The virtues of the brushless DC motor or electronically commutated motor is the capability of providing the user variable speed capability albeit limited pursuant to the physical issues herein described. As all electrical motors and generators must be commutated or develop alternating current in the generation mode, this therefore introduces significant performance limiting physical constraints predicated on hysteresis and eddy current losses. Maximum machine performance is derived in devices where full bipolar excitation and copper (winding) excitation occurs during every current cycle.

Our invention is preferable to existing motors and generators because the magnetic forces are manifest on and in the same direction as the motion rather than perpendicular to such motion. Our invention is more efficient because it utilizes full bipolar excitations of all windings during every current cycle: the stator and rotor windings are excited simultaneously in unison and ideally an equal current levels. Our invention facilitates torque creation free of flux vector components thus consistent forces are manifest upon or the rotor from both sides (inner and outer): No tangential or side induced attraction/repulsion (magnetic) components which contribute to inefficiency are present. As a variant of the device contains no iron the device is devoid of eddy current and hysteresis losses.

### BRIEF SUMMARY OF THE INVENTION

An electromechanical machine capable of functioning as an electric motor or generator/alternator. For application as a motor, all magnetic flux is generated radially thus all forces are generated upon the radius or arc of rotation. The invention incorporates an application specific commutation circuit that transitions the motor variant to a single-phase device. A constant and uninterrupted current flow to the wound rotor is conducted through ball bearings. The generator/alternator function provides for unique self-excitation capabilities and excitation/regulation output control. The invention provides for a flat torque curve over the entire dynamic range of the device, unlike other devices that are limited by back EMF, eddy current, and hysteresis losses.

### BRIEF DESCRIPTION OF THE SEVERAL VIEWS OF THE DRAWING

The supporting drawings submitted here with depict the rotor, stator, conductive bearing assembly and dedicated support electronics/driver/commutator. We have included six drawings including:

FIG. 1 shows an elevated front view of a wound rotor and shaft;

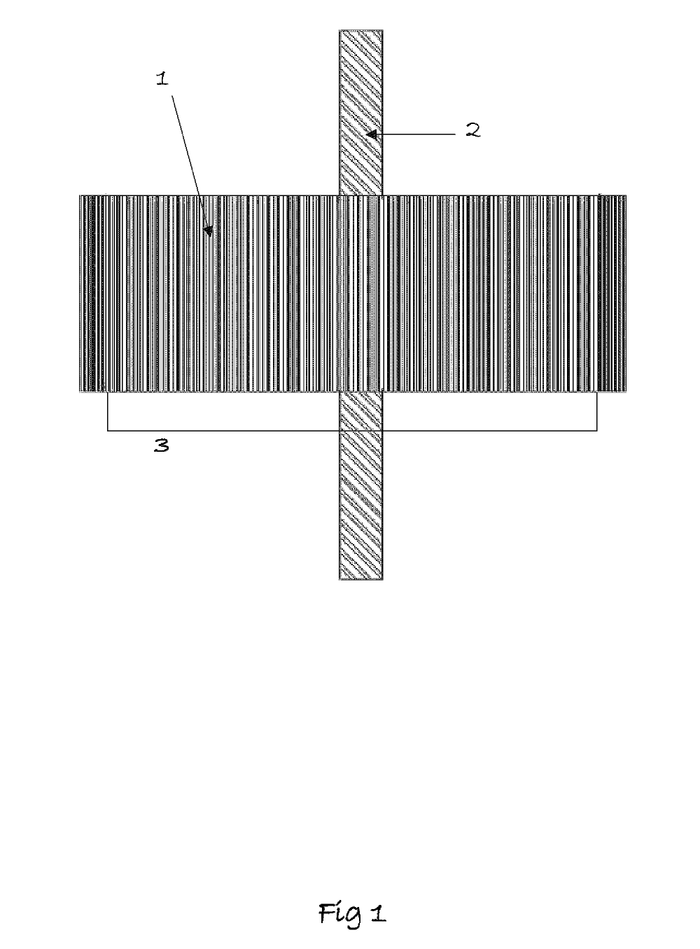

FIG. 2 shows a cutaway plan view of a wound stator;

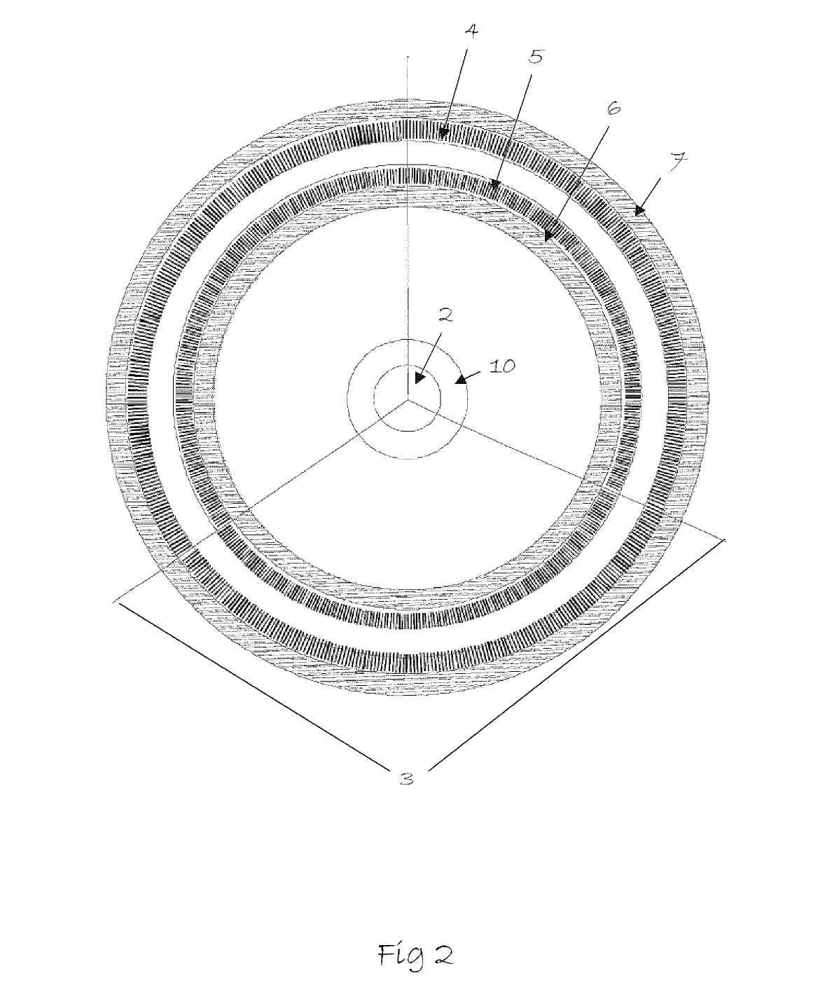

FIG. 3 shows a cutaway elevated front view of wound rotor, shaft, and conductive ball bearings;

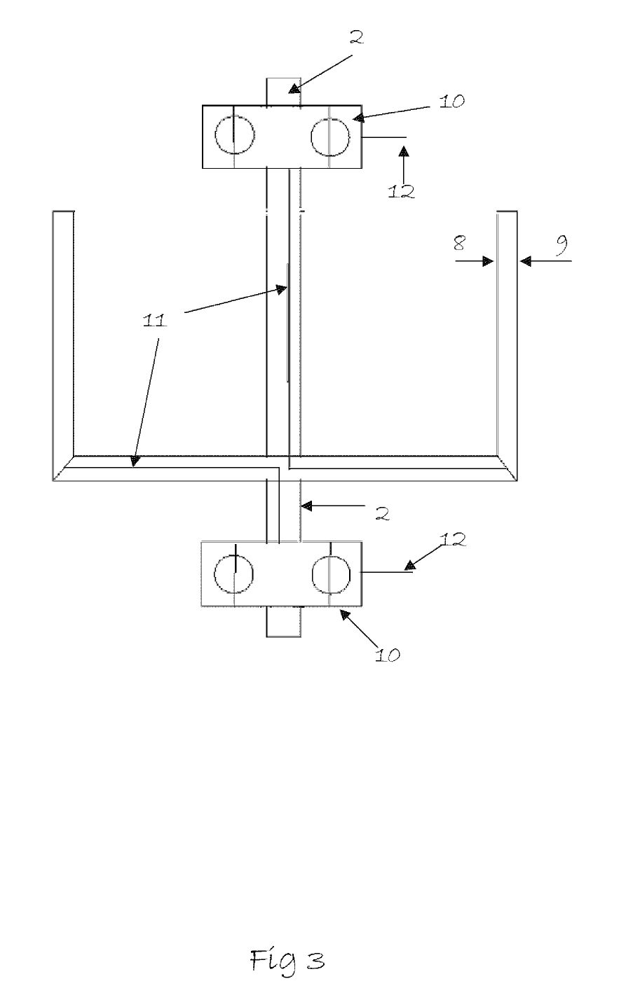

FIG. 4 shows rotor and stator excitation;

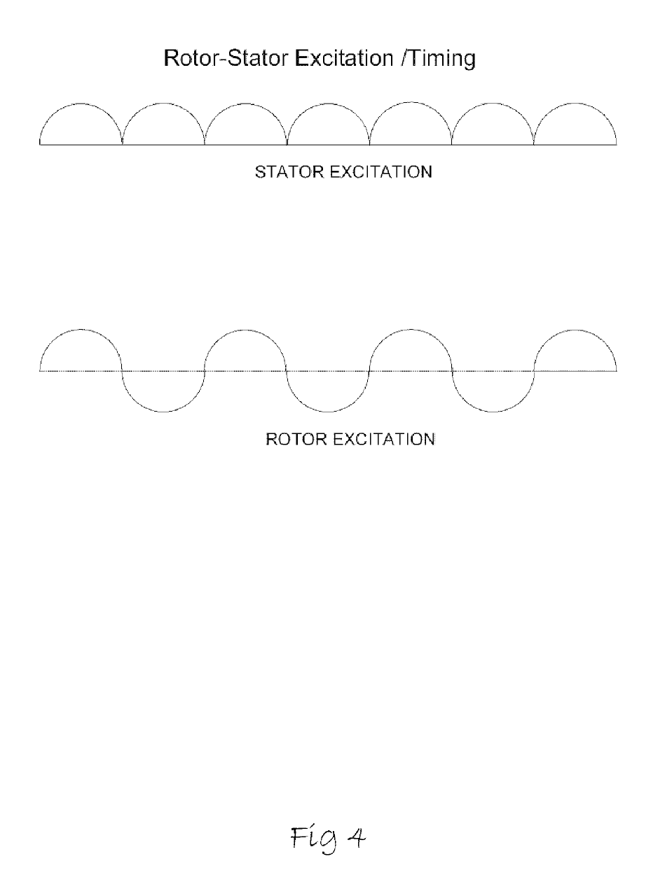

FIG. 5 shows parallel drive control; and

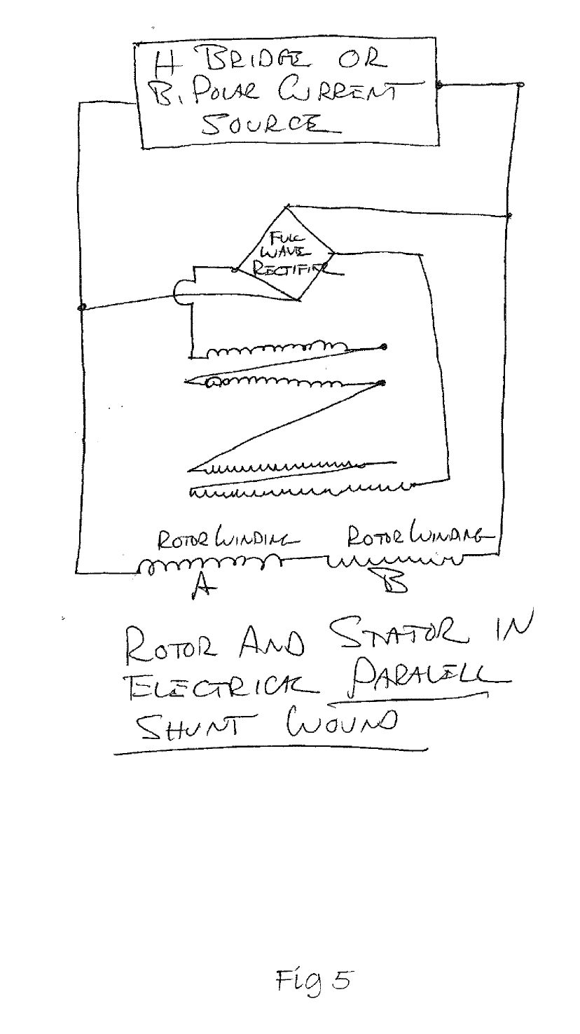

FIG. 6 shows serial drive control.

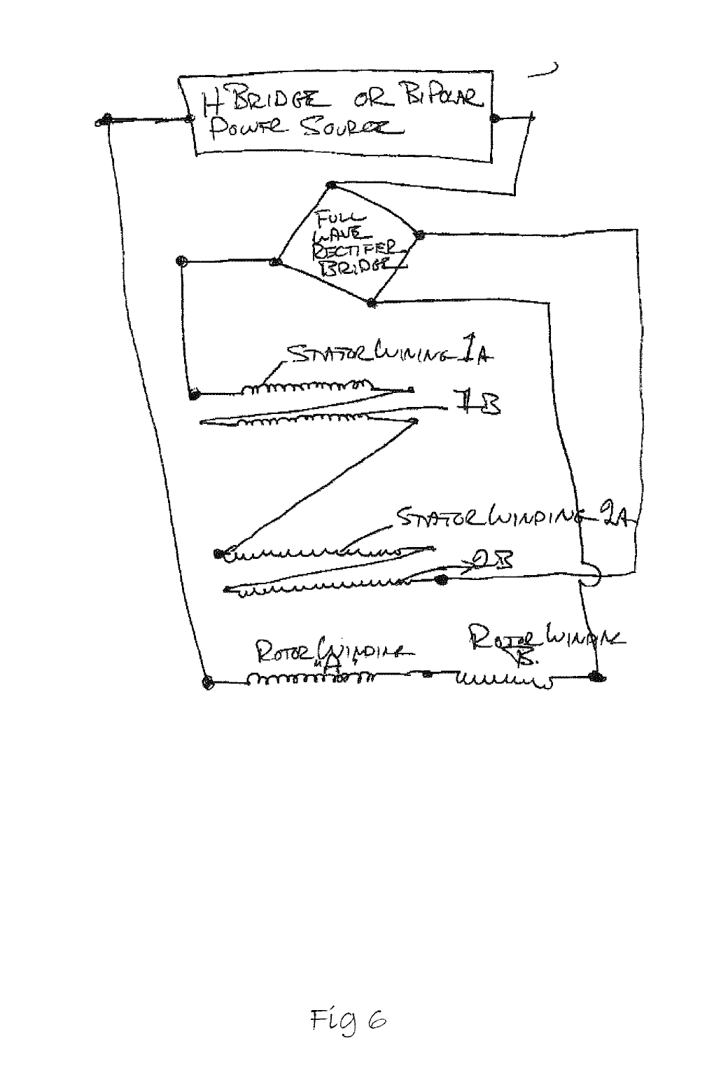

### DETAILED DESCRIPTION OF THE INVENTION:

The components of our invention are: a wound rotor 1 fitted between coaxial stator elements 4,5 that engage magnetically both the inner outer circumference 8,9 of the rotor 1. The rotor 1 is excited via conduction thru the ball bearings 10 that support the rotor 1. The motor is excited via the driver/commutation devices that provide for simultaneous excitation of the stator elements 4,5 and rotor 1. The excitation levels can be controlled to ensure flux intensity rotor 1 to stator elements 4,5 is at parity.

The electric motor variant the subject machine by virtue the application specific drive receives commutated electrical current to the stator elements 4,5 or coils: an exemplary form involves the related commutation/excitation device applying full wave rectified power to the stator element 4,5 windings and in series exciting the rotor simultaneously in alternating polarity; ideally the stator windings 4,5 are in equilibriumare in parity with the rotor windings relative to ampere turns. Given the subject machine may be devoid of iron torque generation is solely predicated on electrical current with the windings of the stator elements 4,5 and rotor 1.

The traditional classification of electrical machines is based on designs that rely on the majority of the magnetic flux being axially induced: The average vector value component of this flux interaction is 90°. Our invention places all windings in physical position so as to induce all magnetic flux/forces radially thus on the ark, radius, and circumference of travel/rotation: The stator and rotor windings are configured such that there height or length dimension is along the radius arc or circumference of travel unlike conventional motors wherein the coil and wire density is expanded or wound progressively, outwardly and at 90° to the machine shaft and the plane of force: The Progression, length or height of the windings stator and rotor is developed along the Ark of travel/rotation: for descriptive purposes the rotor and stator are wound such that the magnet wire is in essence parallel to the shaft of the machine. A variant of this motor utilizes a magnet is a section of an annulus wherein the polls (North/South) are at each and of the annulus section: The permanent magnet can be incorporated into the rotor or stator. The permanent magnet by necessity assumes the same polar profile as its counterpart, the wound electromagnet coil.

Our invention, in the preferred embodiment, utilizes inner and outer stator elements 4,5 between which the rotor 1 travels. Our design applies an equal number of rotor 1 and stator elements 4,5 or coils essentially symmetrically positioned. This magnetic saliency and form would also apply a permanent magnet alternative embodiment.

The stator elements 4,5 and wound rotor 1 can possess any equal number of windings, elements or poles: The permanent magnet variant invokes magnet form/polls of equal geometric position to the wound elements.

The preferred embodiment of our invention, for descriptive purposes, incorporates three stator and rotor windings of equal circumferal occupancy (120°) though the invention could incorporate any number of stator/rotor windings. The adjacent/electrically common stator elements are wound in the same polar orientation. The rotor consists of three windings each occupying 120° of arc 3. The preferred embodiment contains rotor 1 and stator windings 4,5 wound on flat annulus stock. The preferred embodiment incorporates nonferrous material as the substrate for the rotor 1 and for some applications where current time constants are an issue the stator substrate and any encapsulator material 6,7 in close proximity to the stator windings 4,5 is also of a nonferrous material. The preferred winding configuration is coils support structure that it be thin on the axial dimension and wide on the radial dimension.

A variant of the stator elements 4,5 offsets the inner and outer stator sections 4,5 by one half their respective arc of circular occupancy (120° divided by two equals 60° displacement of the outer rotor segment to the inner). The specific values are predicated on three rotor 1 and stator segments 4,5 and is applicable to any predetermined number of rotor stator segments. The aforementioned configuration facilitates improved instantaneous speed variation (ISV) at comparatively low rotational speeds. This variant of the stator eliminates any torque gradient at commutational transitions. This stator configuration requires a driver/commutator connection change: The rotor and one segment of the stator assembly (inner or outer) is excited bipolar while one stator element (inner or outer) is excited full wave unipolar or becomes the only electromagnet within the motor that receives excitation conditioned by a full wave rectifier bridge. Given three stator/rotor segments, commutation transition occur six times per revolution.

The rotor 1 of the subject device achieves electrical connection to the motor exterior via a shaft 2 of either nonconductive material (i.e. ceramic) or electrically isolated conductive material. Electrical connection to the rotor 1 is accomplished by establishing current flow through ball bearings 10 and also provide mechanical support for the rotor. Depending on the reliability and endurance requirements the rotor can also be excited via the application of slip rings and four extremely high commutation rates inductive coupling from the exterior to rotating coils placed upon the rotor 1. Alternate rotor 1 connection methods include but are not limited to Mercury or any other conductive liquid contacts.

Excitation of the subject device when operated as an electric motor shall be accomplished by means of a dedicated driver/commutation device dedicated to the subject motor operation. This commutation circuit/driver is of variants that ensure predictable current levels in the windings. Operation as a motor is based on the machine operating in synchronism with the powering frequency or commutation derived from an independent device such as a Hall sensor or other type of proximity sensor/encoder. Specifically and pertinent to variants where iron is appropriate as a core or an encapsulator 6, 7 of the stator windings 4,5 the magnetic retentivity of the iron (residual magnetism) then exhibits advantages when applied to moderate speed applications. For extremely high speed requirements of all magnetically active components are isolated from ferrous materials for the purpose of minimizing inductance (current time constants).

The electronic driver/commutation device associated with the subject motor can manifest in several variants though the preferred embodiments are described as follows.

As it is preferred but not limited to the rotor 1 is excited with alternating current while the stator elements 4,5 are excited with full wave unipolar (full wave rectifier) excitation. The stator elements 4,5 could also be excited with a constant level direct current and though this is not the preferred embodiment: Excitation of all windings rotor 1 and stator elements 4,5 simultaneously and in electrical series or parallel is preferred. The permanent magnet variant places alternating current on the stator with the stator windings 4,5 in their entirety and being excited in phase simultaneously. This then facilitates predictable and equal flux levels being created by the rotor and stator assembly. As the commutation sequence occurs magnetic flux is generated concurrently by the rotor 1 and stator elements 4,5. Additionally, the flux then deteriorates equally within the rotor 1 and stator elements 4,5 as their source of excitation is common.

The ball bearings 10 supporting the rotor 1 are of the roller or needle type and sealed: ideally their quality level is ABEC 3 or better. Transfer of electrical power to the rotor 1 is achieved by applying power to the outer race 12 of the bearings 10 and finalizing the connection to the rotor by a conductor attachment to the inner race 11 of the bearing 10. Either the rotor shaft 2 is made of a nonconductive material or the bearings are electrically isolated from the shaft 2 thus providing electrical continuity only between the two rotor bearings 10. The lubricant applied to the ball bearings is a commercially available conductive lubricant designed and demonstrated to facilitate the arcless conduction of electrical power through ball bearings 10.

The subject electromechanical device when applied as a motor requires an application-specific electronic drive circuit. The variant of the motor wherein the rotor 1 is constituted by a wound coil or an electromagnet mandates and excitation device as described below.

Ideal overall motor performance and efficiency is realized when the magnetic flux density/value established by the rotor 1 and stator elements 4,5 are in parity. The preferred embodiment of the all electro-magnet variant provides best performance when the stator elements 4,5 are excited full wave unipolar concurrent with bipolar excitation of the rotor 1. The aforementioned phenomenon is critical to establishing residual magnetism in iron situated in or around stator segments 4,5 though and entirely ironless variant (stator sections 4,5). The driver/commutator specific to the wound rotor 1 version of the subject device when applied as a motor is constituted by an alternating current (AC) power source, typically an “H” bridge: The critical objective is to ensure all windings of the motor are energized simultaneously. The preferred embodiment of the commutation device places alternating current on the rotor 1 while the state or windings are energized full wave unipolar via a full wave rectifier bridge. Depending on the operational parameters, the windings in their entirety to include the rotor 1 can be connected electrical series, parallel or a combination of both. The variant utilizing a permanent magnet in the rotor mandates the driver (commutator) to be devoid of the full wave rectifier bridge and thus place alternating current on the stator windings 4,5.

Alternate embodiments include but are not limited to the electromagnet placed upon the rotor 1 being replaced by a permanent magnet. Additionally, any dedicated excitation/commutation device that provides for predictable current levels within the windings is hereby noted for consideration.

The power generation mode and its preferred embodiment places the excitation current on the rotor 1 while the output current is established in the stator windings 4,5. The magnetic flux is induced by the rotor 1 windings and in certain variants of the magnetic flux established (residual magnetism) in any state or related iron.

We claim:

1. An electromechanical apparatus, comprising:
a rotor shaft;
a stator assembly having a central aperture, the stator assembly including an inner stator winding having a plurality of electrically coupled inner stator winding segments and an outer stator winding having a plurality of electrically coupled outer stator winding segments, the inner and outer stator windings being electrically coupled together and disposed to form an annulus between them and all stator windings in physical position so as to induce all magnetic flux or forces radially thus on the ark, radius, and circumference of rotation;
a rotor assembly coupled to the rotor shaft and having a rotor winding disposed within the annulus between the inner and outer stator windings, the rotor winding having a plurality of electrically coupled rotor winding segments and all rotor windings in physical position so as to induce all magnetic flux or forces radially thus on the ark, radius, and circumference of rotation;
a bearing assembly mounted within the housing to position the rotor shaft within the central aperture of the stator assembly, wherein at least a portion of the bearing assembly is of an electrically conductive material;
a first electrical connection between the electrically conductive portion of the bearing assembly and the rotor winding;
a full-wave rectifier having first and second input terminals adapted to accept an alternating current input electrical waveform, the full-wave rectifier having first and second output nodes providing a full-wave rectified output electrical waveform;
a second electrical connection coupling the inner and outer stator windings between the first and second nodes of the full-wave rectifier, wherein the inner and outer stator windings are simultaneously excited by a full-wave rectified output waveform;
a third electrical connection adapted to couple the electrically conductive portion of the bearing assembly to an alternating current electrical source; and
a fourth electrical connection adapted to couple an input terminal of the full-wave rectifier to an alternating current electrical source.

2. The electromechanical apparatus of claim 1, wherein the third and fourth electrical connections comprise an H-bridge motor driver circuit.

3. The electromechanical apparatus of claim 1, wherein the third and fourth electrical connections comprise a bipolar power supply.

4. The electromechanical apparatus of claim 1, wherein the bearing assembly includes a lubricant comprising an electrically conductive material.

5. The electromechanical apparatus of claim 1, wherein the inner and outer stator windings are electrically connected in series.

6. The electromechanical apparatus of claim 1, wherein the rotor winding is excited by an alternating current electrical waveform and the inner and outer stator windings are excited by a full-wave rectified version of the alternating current electrical waveform that excites the rotor winding, the rotor winding excited simultaneously in time with the excitation of the inner and outer stator windings.

7. The electromechanical apparatus of claim 1, wherein the rotor shaft is of an electrically non-conductive material.

8. The electromechanical apparatus of claim 1, wherein the bearing assembly includes an insulator between the electrically conductive portion and the rotor shaft.

9. The electromechanical apparatus of claim 1, further comprising a fifth electrical connection coupling the electrically conductive portion of the bearing assembly to an input terminal of the full-wave rectifier.

10. The electromechanical apparatus of claim 1, wherein the inner stator winding and the outer stator winding are connected together in a series circuit.

11. The electromechanical apparatus of claim 1, wherein the plurality of electrically coupled inner stator winding segments are connected together in a series circuit and the plurality of electrically coupled outer stator winding segments are connected together in a series circuit.
